(19) United States
(12) Patent Application Publication
(10) Pub. No.: US 2007/0262537 A1
(43) Pub. Date: Nov. 15, 2007

(54) Method for the Production of a Flat Seal, and Flat Seal

(76) Inventor: Manfred Klinner, Troisdorf (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 10/559,327

(22) PCT Filed: Apr. 1, 2004
(86) PCT No.: PCT/DE04/00678

§ 371 Date: Oct. 6, 2006

(30) Foreign Application Priority Data
Jun. 3, 2003 (DE) 10324978.8

(51) Int. Cl. F16J 15/02; B23P 17/00

(52) U.S. Cl. 277/594; 29/592

(57) ABSTRACT

A flat metal gasket includes exterior and interior metal gasket parts formed with a gap therebetween and in which elastomeric material is introduced to bridge the parts and form a seal therebetween. The elastomeric material can be formed with one or more media flow openings.

### BACKGROUND OF THE INVENTION

1. Technical Field

The invention relates to a process for manufacturing a flat gasket, and particularly a cylinder head gasket for a combustion engine.

2. Related Art

If an elastomer gasket is required to seal against media such as water or oil, for example in a cylinder head gasket for a combustion engine, certain prerequisites apply to the surfaces to be sealed and to the space required. Two basic possibilities are available in this concept:

Individual gaskets against oil/water. This type of gasket usually has a larger surface area requirement, especially in connection with the gas seal required in the area of the combustion chamber.

The other type of gasket would be a circulating gasket for at least one medium, with a separate gasket for the other medium. This pushes against the limits of current solutions.

So-called ‘On Top Molding’ is generally known and used for sealing of fluid media. A circulating gasket would be possible in this case. This technology requires the use of stopper devices to limit the deformation of the elastomeric bond; to protect the elastomer against destruction. These stoppers are built up of lugs which are supplementally attached to the carrier, and which essentially serve only this function. Also, an additional sealing by means of a discrete element or supplemental lugs on the carrier frame is needed, in conjunction with the necessary gas seal in the combustion chamber area of the motor. The carrier frame alone cannot be used as a gas seal without additional design elements.

One other possibility is so-called “edge molding”, where the edges of the metal carrier frame are sprayed with elastomer for sealing use. With edge molding, the gasket is limited at this time to individual openings. A circulating gasket, combined with a half or full bead in certain lugs is not possible at this time. The typical edge molding, using a free circulating elastomer lip, would be too weak against the relative movements that occur in cylinder head gaskets in a combustion engine, and would immediately be destroyed.

DE-A 40 10 991 discloses a metallic flat gasket, specifically, a cylinder head gasket, with insert ring seals made of metallic-reinforced soft cloth material on the outer surface and having radial protruding ledges inserted into at least one of the duct channels. The ledges are formed by the metallic reinforcing rings. Indentations are stamped into the edge area of the duct channel, corresponding to the ledges of the insertion ring seals. The insertion ring seals are secured against falling out of position by bending and folding of the cavity edge over them.

U.S. Pat. No. 5,267,740 discloses a metal cylinder head gasket with integrated sealing features. Partially interleaving channels are punched in to the channels to guide the flow of media through duct channel openings so that connecting areas arise between the carrier frame and the supports. The supports are equipped with a sealing profile extending beyond their own edge, and beyond the edge of the carrier frame material.

### SUMMARY OF THE INVENTION AND ADVANTAGES

The invention provides a process to meet the requirements of an ever smaller space for the gasket while simultaneously providing for a low cost, and a concurrently providing a simple method flat gasket, especially a cylinder head gasket for a combustion engine.

According to one aspect of the invention, the process involves the manufacture of a flat gasket, specifically a cylinder head gasket for a combustion engine, where at least one metallic carrier material, at least one internal and at least one external metal part having a predefined contour can be separated out, such that the form of the contours, when the pieces are placed together into each other, forms a gap, resulting in at least one sealed area filled with elastomer material.

According to another aspect of the invention, a flat gasket is provided, specifically a cylinder head gasket for a combustion engine, including at least two metal parts having predefined contours, arranged on one level, creating a gap when the pieces are placed together into each other, having at least one sealed area filled with elastomer material.

According to a further aspect of the invention, the at least two metal parts are stamped simultaneously from the same carrier material and the elastomer material is sprayed into the gap between the parts.

According to a further aspect of the invention, the elastomer material is sprayed simultaneously on both sides of the metal parts, such that an encapsulated profile is formed. This elastomer profile runs completely around for sealing of a medium, and advantageously encircles other media which must also be sealed into the internal area. The advantage of the use of metal parts from the same carrier metal is based on the premise that varying sheet metal thicknesses can be avoided.

According to a further aspect of the invention, the at least two parts include an internal metal part and or external metal part. The internal metal part can additionally serve as an individual gasket to seal other small holes via edge molding, and thereby seal up at least a second medium. If the flat gasket is a cylinder head gasket, then the combustion chamber duct channels can be foreseen in the inner metal parts, and be equipped with a stamped bead.

According to a further aspect of the invention, the deformation of the elastomer material is limited by the metal parts placed together into each other in the one level.

In this simple way, a single layer metallic flat gasket, especially a cylinder head gasket, can be advantageously manufactured. The use of thick sheet metal design with edge molding can provide a relatively significant savings as compared to the more complicated on-top molding. As a result of the encapsulated edge molding, the elastomer material is less sensitive to relative motion and is held in position.

Compared to the state of the art, a reduction in the space needed for an individual seal, and between a gas seal and, for example, water and oil media, is realized with the encircling seal compared to the individual seal.

### THE DRAWINGS

These and other features and advantages of the present invention will become more readily appreciated when considered in connection with the following detailed description and appended drawings, wherein:

FIG. 1 is a fragmentary top view looking down onto a cylinder head gasket as per the invention; and

FIG. 2 is a fragmentary cross-sectional view of the gasket of FIG. 1.

### DETAILED DESCRIPTION

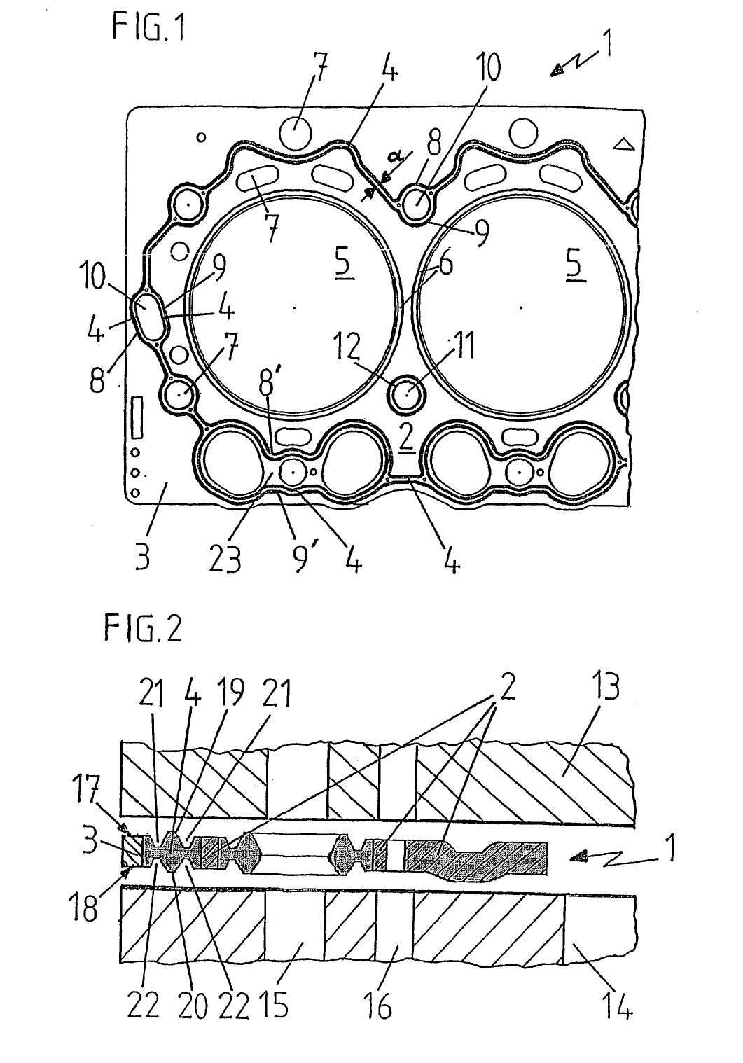

FIG. 1 depicts a cylinder head gasket 1 for a combustion engine (not shown). The cylinder head gasket 1 includes an internally mounted metal part 2 and an externally attached metal part 3, which may be stamped out of the same material, forming a gap therebetween.

The matching contours of the metal parts 2, 3 are to be fitted into the same geometric profile of the individual combustion engines in a corresponding manner. In this example, beginning from the adjusting edge, elastomer material 4 is to be sprayed into the gap a formed by the circulating channel. The elastomer material 4 thereby forms a circulating (i.e., circumferentially continuous) sealed area where the distortion of the elastomer material 4 is limited by the single layer cylinder head gasket 1, made of the metal parts 2,3. The internal metal part 2 is equipped with at least one combustion chamber duct channel opening 5, that is stamped out at the same time as the production of metal parts 2,3. There may be formed a plurality of such openings 5, and at each combustion chamber duct channel opening, at least one bead 6 is stamped in to surround the opening 5. In like manner, holes 7 may be stamped into internal and external metal parts 2,3, which may serve different purposes; for example, as bolt holes for mounting of the cylinder head gasket 1. Further, the shaping of the metal parts 2,3 may be carried out in such a way that recesses facing each other 8, 9 are formed, and are then generated in the same run of elastomer material 4 with the media flow through channels 10 being formed in the elastomer in the vicinity of the recesses 8, 9. Additional media flow through holes 11 may be formed in the internal metal part 2 and covered with elastomer material 12 by edge molding.

FIG. 2 shows a schematic fragmentary cross section of the cylinder head gasket 1 installed as per FIG. 1. Cylinder head 13 and cylinder block 14 are shown. Using reference mark 15, 16 the constructed areas of the cylinder block for guiding the flow of oil 15 and water 16 are indicated. One can also make out a portion of the internal metal part 2, and a portion of external metal part 3. The elastomer material 4 running around the area forms a first sealed area, whereby the protruding profile 19, 20 of the frontal surface 17, 18 on metal parts 2, 3 is sprayed. In assembling the cylinder head gasket 1, specifically when cylinder head 13 is placed onto cylinder block 14, and is firmly attached by parts which are not depicted herein, the elastomer material of the profile bodies 19, 20 can move expansively into the free spaces 21, 22 preformed or shaped into the elastomer material 4. The distortion of the elastomer material 4 is limited solely by the thickness of metal parts 2, 3.

The metal parts 2, 3 can be equipped with additional saved areas of adjoining spaces 8′, 9′, as the need arises. These regions may be spaced at larger distances between each other than regions 8, 9, and can accept individual insert metal parts 23, that have been attached with internal metal parts 2 and/or external metal parts 3, in the course of the spraying process of the elastomer material 4.

1-17. (canceled)

18. A process for the manufacture of a flat metal gasket for an internal combustion engine, comprising:
forming at least one internal flat metal gasket part having a cut-out region;
forming at least one internal flat metal gasket part;
positioning the at least one internal flat metal gasket part within the cut-out region of the at least one external flat metal and forming a gap between an outer edge of the at least one interior flat metal gasket part and an interior edge of the at least one external flat metal gasket part; and
introducing elastomer material into the gap to connect the at least one external and internal metal parts across the gap.

19. The process of claim 18 wherein the at least one external and internal gasket parts are formed from a common piece of flat metal gasket carrier material.

20. The process of claim 19 where the at least one external and internal gasket parts are stamped out of the common piece of flat metal gasket carrier material.

21. The process of claim 18 wherein the filling of the gap is carried out by spraying the elastomer material into the gap.

22. The process of claim 21 wherein the gap is open to opposite frontal faces of the gasket parts and the elastomer material is sprayed into the gap from both frontal faces.

23. The process of claim 18 wherein an opening is formed in at least one of the external or internal gasket parts.

24. The process of claim 23 wherein the at least one opening is formed during the formation of the at least one metal part in which it is formed.

25. The process of claim 23 wherein elastomer material is molded about an edge of the at least one opening.

26. The process of claim 18 wherein the gap is formed with at least one widened recess region and the elastomer is shaped in the at least one recess region to form at least one media flow opening therethrough.

27. The process of claim 18 wherein the at least one internal gasket part is formed with at least one combustion chamber opening and forming at least one stamped seal bead around the opening.

28. The process of claim 18 wherein the gap is formed with at least one widened recess region in which another flat metal gasket part is arranged and joined by the elastomer material introduced to the gap.

29. A flat metal gasket assembly, comprising:
at least one external metal gasket part having a cut-out region;
at least one internal metal gasket part arranged in said cut-out region of said at least one exterior metal gasket part in generally coplanar relationship and defining a gap therebetween; and
an elastomer material disposed in the gap and bridging the at lest one external and internal metal gasket parts.

30. The assembly of claim 19 including at least one combustion chamber opening formed in said at least one interior metal gasket part.

31. The assembly of claim 29 including at least one media flow opening formed in said elastomer material in said gap.

32. The assembly of claim 29 wherein the at least one external and internal metal parts include a widened recess region in which an opening is formed in said elastomer material within said recessed region.

33. The assembly of claim 29 wherein said elastomer material includes a sealing portion projecting out of said gap beyond opposite faces of said at least one external and internal metal gasket parts.

34. The assembly of claim 33 wherein said elastomer material is contoured in the vicinity of said sealing portion so as to accommodate compression and displacement of said sealing portion when clamped between two members to be sealed.

35. The assembly of claim 30 including at least one stamped sealing bead surrounding said at least one combustion opening.

36. The assembly of claim 29 wherein at least one opening is formed in at least one of said external and internal metal parts, said at least one opening including an edge molding of elastomer material.
